(19) United States
(12) Patent Application Publication
(10) Pub. No.: US 2025/0126654 A1
(43) Pub. Date: Apr. 17, 2025

(54) METHOD FOR EXECUTING RANDOM ACCESS RESOURCE SELECTION AND USER EQUIPMENT USING THE SAME

(71) Applicant: Industrial Technology Research Institute, Hsinchu (TW)

(72) Inventor: Ching-Wen Cheng, Hsinchu County (TW)

(73) Assignee: Industrial Technology Research Institute, Hsinchu (TW)

(21) Appl. No.: 18/908,817

(22) Filed: Oct. 8, 2024

Related U.S. Application Data
(60) Provisional application No. 63/589,635, filed on Oct. 12, 2023.

(51) Int. Cl. H04W 74/0833

(52) U.S. Cl. CPC H04W 74/0833

(57) ABSTRACT

The present disclosure provides a method for executing random access resource selection in UE served by an NTN. The method includes: detecting a synchronization signal block (SSB) transmitted by an NTN cell, based on a predefined communication resource associated with the SSB; determining an identifier (ID) associated with the detected SSB; maintaining assistance information, wherein the assistance information comprises at least one of the following: first information associated with a presentation order of the detected SSB; and second information associated with an available service duration d of a random access resource associated with the detected SSB; selecting one of the detected SSB as a first SSB based on the assistance information when a plurality of SSB are detected; and applying a random access resource associated with the first SSB for performing a random access procedure.

### CROSS-REFERENCE TO RELATED APPLICATION

This application claims the priority benefit of U.S. provisional application Ser. No. 63/589,635, filed on Oct. 12, 2023. The entirety of the above-mentioned patent application is hereby incorporated by reference herein and made a part of this specification.

### BACKGROUND

### 1. Field of the Invention

The present disclosure generally relates to a resource selection mechanism, in particular, to a method for executing random access resource selection and user equipment (UE) using the same method.

### 2. Description of Related Art

NTN (Non-Terrestrial Networks) refers to communication systems that leverage non-terrestrial platforms, such as satellites, high-altitude platforms (HAPs), and unmanned aerial vehicles (UAVs), to provide network coverage.

Unlike traditional terrestrial networks that rely on ground-based infrastructure like cell towers, NTNs can deliver communication services to remote, rural, or underserved areas where conventional networks may be impractical or too costly to deploy.

See FIG. 1, which shows a schematic diagram of a deployed multi-beam NTN cell. In a multi-beam NTN cell 100 (which exemplarily provide Beam 0 to Beam 6) as shown in FIG. 1, the Synchronization Signal PBCH block (SSB) may be transmitted using time division multiplexing (TDM) across adjacent beams of the NTN cell to prevent inter-beam interference. Each beam of an NTN cell is associated with a specific SSB index, ensuring that signals are properly identified and managed within the network.

For example, SSB 0 of Cell 1 (e.g., the multi-beam NTN cell 100) may be transmitted on the frequency f1 by using Symbols 2 to 5 in Slot 0, SSB 1 of Cell 1 may be transmitted on the frequency f1 by using Symbols 8 to 11 in Slot 0, and SSB 2 of Cell 1 may be transmitted on the frequency f1 by using Symbols 2 to 5 in Slot 1, wherein the associated subcarrier spacing (SCS) may be 15 kHz, and the maximum number of SSB indexes in a cell may be L (e.g., 4).

In some cases, a single geographical area can be served by more than one beam from an NTN cell. When UEs detect a plurality of beams in RRC_IDLE or RRC_INACTIVE states within these areas, they select one SSB based on predefined criteria and proceed with the random access process.

Taking FIG. 1 as an example, for the UEs locating in the area 111 (which is covered by Beam 0 and Beam 1), these UEs may detect both Beam 0 and Beam 1 provided by Cell 1. Likewise, for the UEs locating in the area 112 (which is covered by Beam 1 and Beam 2), these UEs may detect both Beam 1 and Beam 2 provided by Cell 1.

For these UEs, one of the detected beams (and/or SSBs) may be selected for being used in the following random access process. However, if the UE in the NTN cannot properly perform the selection of beams (and/or SSBS), impactful latency may be introduced, which may seriously affect the performance of the NTN cell.

### SUMMARY OF THE INVENTION

Accordingly, the disclosure is directed to a method for executing random access resource selection and UE using the same method, which may be used to solve the above

### Technical Problems

The present disclosure provides a method for executing random access resource selection in UE served by an NTN. The method includes: detecting, by the UE, a synchronization signal PBCH block (SSB) transmitted by an NTN cell, based on a predefined communication resource associated with the SSB; determining, by the UE, an identifier (ID) associated with the detected SSB; maintaining, by the UE, assistance information, wherein the assistance information comprises at least one of the following: first information associated with a presentation order of the detected SSB; and second information associated with an available service duration of a random access resource associated with the detected SSB; selecting, by the UE, one of the detected SSB as a first SSB based on the assistance information when a plurality of SSB are detected; and applying, by the UE, a random access resource associated with the first SSB for performing a random access procedure.

The present disclosure provides UE, including a transceiver and a processor. The processor is coupled to the transceiver and configured to perform: controlling the transceiver to detect a SSB transmitted by an NTN cell, based on a predefined communication resource associated with the SSB; determining an ID associated with the detected SSB; maintaining assistance information, wherein the assistance information comprises at least one of the following: first information associated with a presentation order of the detected SSB, and second information associated with an available service duration of a random access resource associated with the detected SSB; selecting one of the detected SSB as a first SSB based on the assistance information when a plurality of SSB are detected; and applying a random access resource associated with the first SSB for performing a random access procedure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a deployed multi-beam NTN cell.

FIG. 2A shows a schematic diagram of a Quasi-earth-fixed multi-beam NTN cell.

FIG. 2B shows a schematic diagram of an Earth-moving multi-beam NTN cell.

FIG. 3A shows a schematic diagram of the resource selection in a terrestrial network (TN).

FIG. 3B shows a schematic diagram of the resource selection in an NTN.

FIG. 4 shows a functional block diagram of UE according to an embodiment of the disclosure.

FIG. 5 shows a flow chart of the method for executing random access resource selection according to an embodiment of the disclosure.

FIG. 6 shows a schematic diagram according to the first embodiment of the disclosure.

FIG. 7A to FIG. 7C show several schematic diagrams of determining whether the SSB is detected according to embodiments of the disclosure.

FIG. 8 shows a schematic diagram according to an embodiment of the disclosure.

FIG. 9 shows a schematic diagram of providing distance indicators as the second information according to the second embodiment of the disclosure.

FIG. 10 shows a flow chart of the UE organizing the detection order list according to an embodiment of the disclosure.

FIG. 11 shows schematic diagrams of removing an SSB from the detection order list according to an embodiment of the disclosure.

FIG. 12 shows schematic diagrams of removing an SSB from the detection order list according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

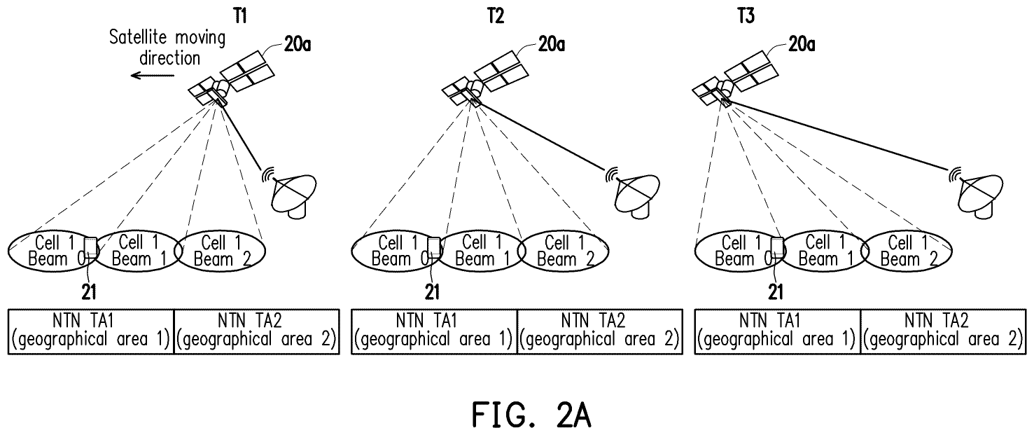

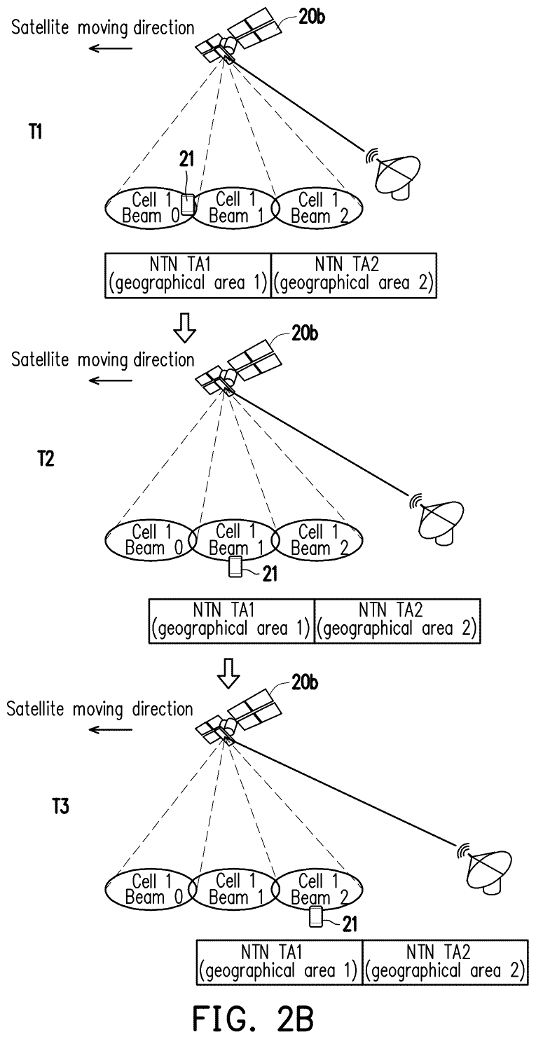

See FIG. 2A, which shows a schematic diagram of a Quasi-earth-fixed multi-beam NTN cell. In FIG. 2A, the satellite 20a may move along the shown direction, such that the satellite 20a may be at different positions at different time points T1 to T3. In this case, the satellite 20a may provide Quasi-Earth-fixed beams (e.g., Beam 0 to Beam 2) to cover a specific geographic area for a limited period before switching to another different geographic area during another period. This is commonly seen in the case of Non-Geostationary Orbit (NGSO) satellites that generate steerable beams.

In the case of FIG. 2A, the UEs in or moving into a geographic area served by more than one beam of the cell would observe multiple SSB identifiers (IDs). Additionally, as these UEs moves across the coverage of different beams within the cell, it would observe changes in the SSB ID.

For example, for the UE 21 locating in the geographical area 1 (which corresponds to NTN tracking area (TA) 1), the UE 21 may firstly detect the SSB ID corresponding to Beam 0 of Cell 1. As the UE 21 moves along the satellite moving direction as shown in FIG. 2A, the UE 21 may determine that the detected SSB ID has changed from corresponding to Beam 0 to correspond to Beam 1 of Cell 1.

Further, as the UE 21 moves more along the satellite moving direction as shown in FIG. 2A to enter the geographical area 2 (which corresponds to NTN TA 2) the UE 21 may determine that the detected SSB ID has changed from corresponding to Beam 1 to correspond to Beam 2 of Cell 1.

See FIG. 2B, which shows a schematic diagram of an Earth-moving multi-beam NTN cell. In FIG. 2B, the satellite 20b may move along the shown direction, such that the satellite 20b may be at different positions at different time points T1 to T3. The satellite 20b may provide earth-moving beams having coverage sliding over the Earth's surface, which can be understood as the case where NGSO satellites that generate fixed or non-steerable beams.

In the case of FIG. 2B, the UEs located in or moving into a geographic area served by more than one beam of the cell would observe multiple SSB IDs. As the serving beam changes along with the satellite's movement or when the UE moves across the coverage of different beams within the cell, the UE would observe changes in the SSB ID.

For example, for the UE 21 locating in the geographical area 1 (which corresponds to NTN TA 1), the UE 21 may detect the SSB ID corresponding to Beam 0 of Cell 1 at the time point T1. At the time point T2, since the satellite 20b has moved to another position, the beam serving the UE 21 may become Beam 1 of Cell 1, such that the UE 21 may determine that the detected SSB ID has changed from corresponding to Beam 0 to correspond to Beam 1 of Cell 1. At the time point T3, since the satellite 20b has further moved, the beam serving the UE 21 may become Beam 2 of Cell 1, such that the UE 21 may determine that the detected SSB ID has changed from corresponding to Beam 1 to correspond to Beam 2 of Cell 1.

For the UE in the RRC_IDLE or RRC_INACTIVE states, when the UE detects multiple SSB IDs at the same time, the UE may select one of the beams corresponding to these SSB IDs as the beam for performing a random access procedure. However, since the beams corresponding to the detected SSB IDs may have different serving time with respect to the UE, if the UE selects the beam with a shorter available service duration for performing a random access procedure, the available service duration of the beam may not be sufficient to complete the random access procedure and thus the UE may need to select other beam for performing random access procedure within a short time, which may introduce additional latency.

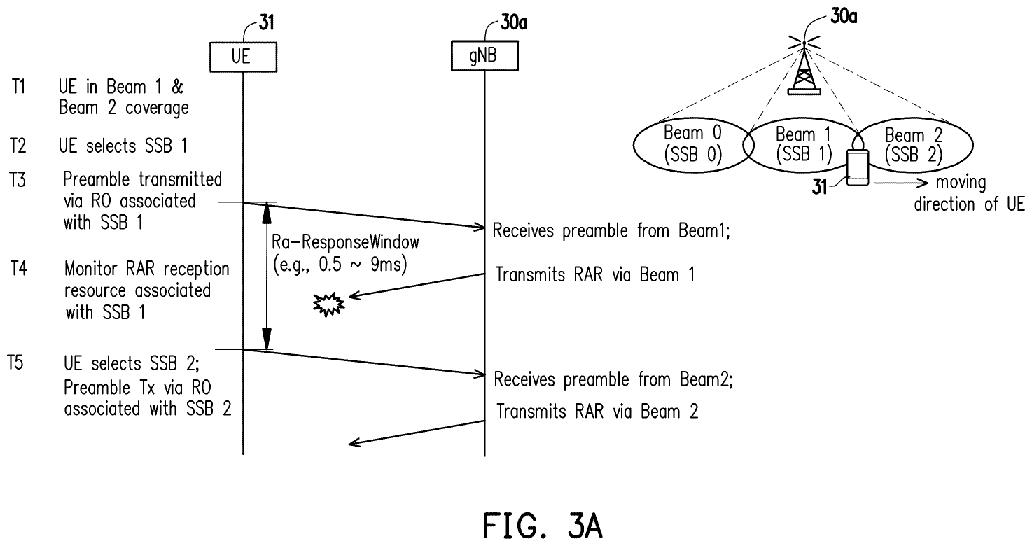

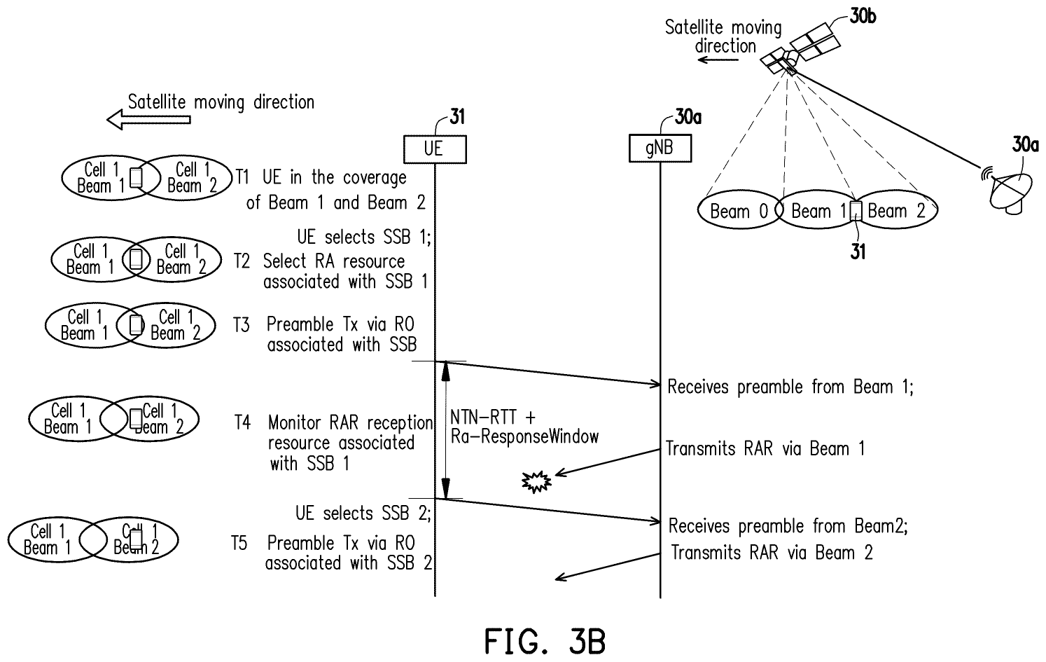

See FIG. 3A, which shows a schematic diagram of the resource selection in a terrestrial network (TN). In FIG. 3A, the UE 31 may be assumed to be in the coverage of Beam 1 and Beam 2 at the time point T1, such that the UE 31 can detect the SSB 1 and SSB respectively corresponding to Beam 1 and Beam 2 at the time point T1. In addition, the UE 31 may be further assumed to be moving along the satellite moving direction as shown in FIG. 3A.

As can be seen from FIG. 3A, based on the moving direction of the UE 31, Beam has a longer available service duration with respect to the UE 31 than Beam 1. However, since the UE 31 can detect the SSB 1 and SSB 2, the UE 31 may select SSB1 at the time point T2 and accordingly perform the random access.

Specifically, at the time point T3, the UE 31 may transmit a preamble via the random access occasion (RO) associated with the selected SSB1.

In FIG. 3A, the UE 31 may transmit the preamble via Beam 1 corresponding to SSB1, and hence the gNB 30a providing Beam 0 to Beam 2 may receive the preamble from the UE 31 via Beam 1.

Afterwards, the gNB 30a may use Beam 1 to transmit a random access response (RAR) to the UE 31. Meanwhile, the UE 31 may determine whether the RAR has been received from the gNB 30a via Beam 1 within a predetermined time window (referred to as “ra-Response Window”) after the time point T3.

However, assuming that the UE 31 has left the coverage of Beam 1 at the time point T4, this makes the UE 31 cannot receive the RAR from the gNB 30a via Beam 1 within the predetermined time window (e.g., 0.5 to 9 ms). In this case, at the time point T5, the UE 31 may select SSB 2 and transmit another preamble via the RO associated with the selected SSB 2. For example, the UE 31 may transmit the preamble via Beam 2 corresponding to SSB 2, and hence the gNB 30a may receive the preamble from the UE 31 via Beam 2.

Afterwards, the gNB 30a may use Beam 2 to transmit a RAR to the UE 31. If the available service duration of Beam 2 is sufficient for the performing of a random access procedure, the UE 31 will be able to receive this RAR and performing the following steps of the random access procedure accordingly to complete the random access procedure successfully.

In FIG. 3A, since it is a scenario of TN, the latency introduced due to improperly selection of SSB may be neglectable. However, in the scenario of NTN, the latency introduced due to improperly selection of SSB may be impactful.

See FIG. 3B, which shows a schematic diagram of the resource selection in an NTN. In FIG. 3B, the UE 31 may be assumed to be in the coverage of Beam 1 and Beam at the time point T1, such that the UE 31 can detect the SSB 1 and SSB 2 respectively corresponding to Beam 1 and Beam 2 at the time point T1. Different from FIG. 3A, the UE 31 may be assumed to be non-moving or semi-static, but the satellite 30b is assumed to be moving along the satellite moving direction as shown in FIG. 3B.

As can be seen from FIG. 3B, based on the moving direction of the satellite 30b,

Beam 2 has a longer available service duration with respect to the UE 31 than Beam 1.

However, since the UE 31 can detect the SSB 1 and SSB 2, the UE 31 may select SSB1 at the time point T2 and accordingly perform the random access by using the random access resource associated with SSB 1.

Specifically, at the time point T3, the UE 31 may transmit a preamble via the random access occasion (RO) associated with the selected SSB1.

In FIG. 3B, the UE 31 may transmit the preamble via Beam 1 corresponding to SSB1, and hence the gNB 30a providing Beam 0 to Beam 2 may receive the preamble from the UE 31 via Beam 1. However, since the preamble needs to be forwarded by the satellite 30b to the gNB 30a, the transmission path and the propagation delay of the preamble would be longer than the case in FIG. 3A.

Afterwards, the gNB 30a may use Beam 1 to transmit an RAR to the UE 31.

Meanwhile, the UE 31 may determine whether the RAR has been received from the gNB 30a via Beam 1 within a predetermined time window after the time point T3. However, considering the transmission path and propagation delay between the UE 31 and the gNB 30a is obviously longer than the case of FIG. 3A, the predetermined time window used in FIG. 3B may be designed to be longer than the predetermined time window used in FIG. 3A.

Based on parameters such as the moving speed of the satellite 30b, the size of the NTN cell coverage, etc., the NTN round trip time (RTT) between the UE 31 and the gNB 30a may range from several to hundreds or milliseconds. Therefore, the predetermined time window used in FIG. 3B may be designed to be a sum of the NTN RTT and the “ra-Response Window”.

It is possible that the UE 31 has left the coverage of Beam 1 at the time point T4, this makes the UE 31 cannot receive the RAR from the gNB 30a via Beam 1 within the predetermined time window in FIG. 3B. In this case, at the time point T5, the UE 31 is located in the coverage of Beam 2 and may select SSB 2 and transmit another preamble via the RO associated with the selected SSB 2. For example, the UE 31 may transmit the preamble via Beam 2 corresponding to SSB 2, and hence the gNB 30a may receive the preamble from the UE 31 via Beam 2.

Afterwards, the gNB 30a may use Beam 2 to transmit a RAR to the UE 31. If the available service duration of Beam 2 is sufficient for the performing of a random access procedure, the UE 31 would be able to receive the RAR and to perform the following steps of the random access procedure accordingly to complete the random access procedure successfully.

As can be seen from FIG. 3B, if the UE 31 selects a SSB associated with a beam without sufficient available service duration for performing a random access procedure, the introduced latency would be much severe than the case of FIG. 3A.

More specifically, due to the long propagation delay between UE and the gNB, the time needed for a UE to discovery the failure of RAR reception is not negligible in NTN scenario. The failure of RAR reception due to insufficient available service duration of a Beam need to be prevented.

Accordingly, embodiments of the disclosure have provided a solution for resolving the above problem, which would be discussed in the following.

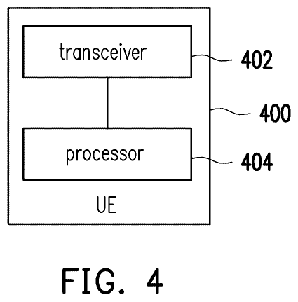

See FIG. 4, which shows a functional block diagram of UE according to an embodiment of the disclosure.

In FIG. 4, the UE 400 includes a transceiver 402 and a processor 404. The transceiver 402 may be configured for transmitting and receiving signals from other devices within a coverage area thereof. The transceiver 402 is capable of performing analog to digital signal conversion (ADC), digital to analogue signal conversion (DAC), modulation, demodulation, signal amplification, low-pass filtering, and bandpass filtering. For example, the transceiver 402 is configured to provide information on a received signal to the processor 404, modulating data received from the processor 404 into a modulated signal, and transmitting the modulated signal to other devices.

In some embodiments, the UE 400 may further include other elements, such as an antenna module for implementing the aforementioned functions of the transceiver 402 and the processor 404.

The processor 404 may be coupled with the transceiver 402, and the processor 404 may be, for example, a general purpose processor, a special purpose processor, a conventional processor, a digital signal processor (DSP), a plurality of microprocessors, one or more microprocessors in association with a DSP core, a controller, a microcontroller,

Application Specific Integrated Circuits (ASICs), Field Programmable Gate Array (FPGAs) circuits, any other type of integrated circuit (IC), a state machine, and the like.

In the embodiments of the disclosure, the transmissions/receptions of the UE may be performed by the processor of the UE controlling the transceiver of the UE.

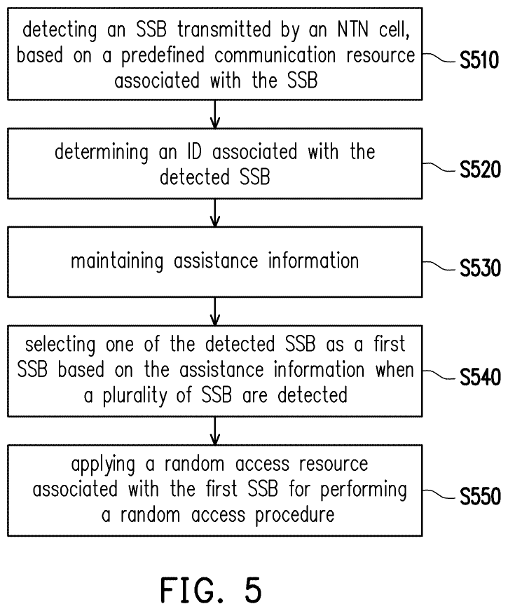

See FIG. 5, which shows a flow chart of the method for executing random access resource selection according to an embodiment of the disclosure. The method of this embodiment may be executed by the UE 400 in FIG. 4, and the details of each step in FIG. will be described below with the components shown in FIG. 4.

In step S510, the UE 400 detects an SSB transmitted by an NTN cell, based on a predefined communication resource associated with the SSB.

In the embodiments of the disclosure, the NTN cell may be the serving cell of the UE 400, and the NTN cell may provide a plurality of beams, wherein each of the plurality of beams may correspond to predetermined SSB.

For example, the UE 400 may be the UE 21 in FIG. 2A and/or FIG. 2B, and the NTN cell may be Cell 1 in FIG. 2A and/or FIG. 2B. In this case, Beam 0 to Beam 2 of

Cell 1 may be regarded and the corresponding predetermined beams, but the disclosure is not limited thereto.

In the embodiments of the disclosure, the predetermined SSBs may be transmitted on the corresponding predefined communication resources, and the UE 400 may detect one or more of the predetermined SSBs based on the corresponding predefined communication resources.

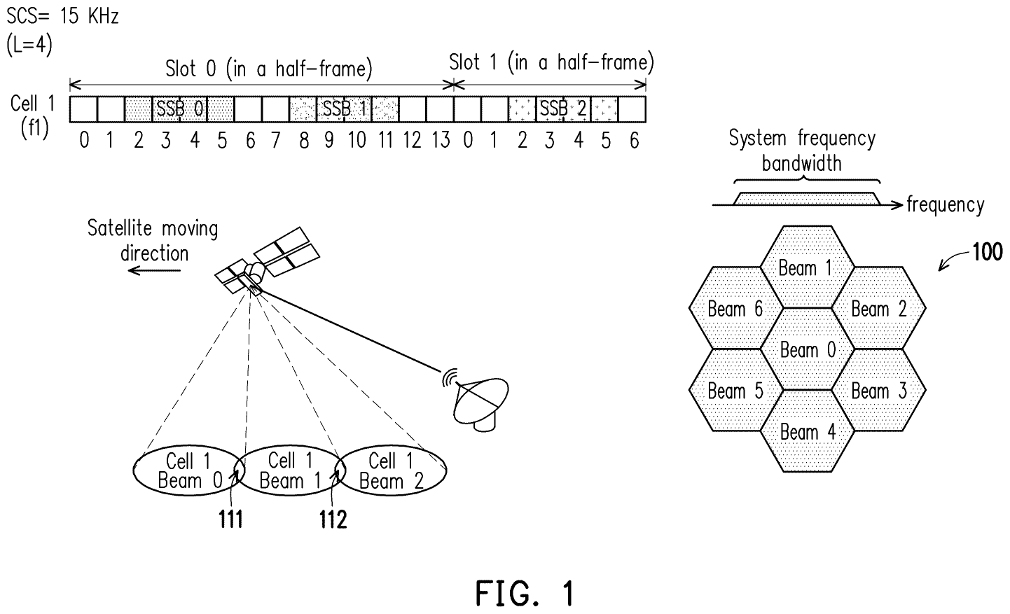

Taking FIG. 1 as an example, the predetermined SSBs may exemplarily include SSB 0 to SSB 2, wherein the predefined communication resource corresponding to SSB 0 may include the frequency f1 and Symbols 2 to 5 in Slot 0, the predefined communication resource corresponding to SSB 1 may include the frequency f1 and Symbols 8 to 11 in Slot 0, and the predefined communication resource corresponding to SSB 2 may include the frequency f1 and Symbols 2 to 5 in Slot 1, but the disclosure is not limited thereto.

In step S520, the UE 400 determines an ID associated with the detected SSB.

In one embodiment, the detected SSB may be one of the predetermined SSBs.

For example, if the location of the UE 400 is only within the coverage of a specific beam (e.g., Beam 0 in FIG. 1) of the predetermined beams, the SSB detected by the UE 400 would be the SSB corresponding to the specific beam (e.g., SSB 0). In this case, the UE 400 may determine the ID of SSB 0 as the ID considered in step S520.

In some embodiments, the UE 400 may determine a plurality of SSBs are detected if more than one of the predetermined SSBs are detected. For example, if the location of the UE 400 is within the coverages of multiple specific beams of the predetermined beams, the SSB detected by the UE 400 would be the SSBs corresponding to the multiple specific beams.

In a first example, if the UE 400 locates in the area 111 covered by both of Beam and Beam 1 of FIG. 1, Beam 0 and Beam 1 may be regarded as the considered specific beams. In this case, the UE 400 would be able to detect SSB 0 and SSB 1 after Slot 0 passes, and hence SSB 0 and SSB 1 would be considered as the plurality of detected SSBs. In this case, the UE 400 may determine the ID of SSB 0 as the ID considered in step S520 as SSB 0 is detected and determine the ID of SSB 1 as the ID considered in step S520 as SSB 1 is detected.

In addition, the UE 400 locating in the area 111 would not be able to detect SSB 2 in Slot 1 since the UE 400 is not in the coverage of Beam 2, but the disclosure is not limited thereto.

In some embodiments, a detected SSB can also be understood/regarded as an available SSB, but the disclosure is not limited thereto.

In step S530, the UE 400 maintains assistance information.

In various embodiments, the assistance information includes at least one of first information and second information. In a first embodiment, the first information is associated with a presentation order of the detected SSB. In a second embodiment, the second information is associated with an available service duration of a random access resource associated with the detected SSB. Details of the first information and the second information would be further discussed with other embodiments in the following.

In step S540, the UE 400 selects one of the detected SSB as a first SSB based on the assistance information when a plurality of SSB are detected.

In step S550, the UE 400 applies a random access resource associated with the first SSB for performing a random access procedure.

In the first example mentioned in the above, since the UE 400 has detected multiple SSBs (e.g., SSB 0 and SSB 1), the UE 400 may select one of the detected SSB 0 and SSB 1 as the first SSB based on the assistance information. Next, the UE 400 may determine the beam corresponding to the first SSB and the random access resource associated with the first

SSB (wherein this random access may be referred to as a first random access resource), and applies the random access resource associated with the first SSB for performing the random access procedure.

For example, if the UE 400 locating in the area 111 selects SSB 0 as the first SSB based on the assistance information, the UE 400 may determine the corresponding random access resource associated with Beam 0 as the first random access resource, and applies the random access resource associated with Beam 0 for performing the random access procedure.

For another example, if the UE 400 locating in the area 111 selects SSB 1 as the first SSB based on the assistance information, the UE 400 may determine the corresponding random access resource associated with Beam 1 as the first random access resource, and applies the random access resource associated with Beam 1 for performing the random access procedure, but the disclosure is not limited thereto.

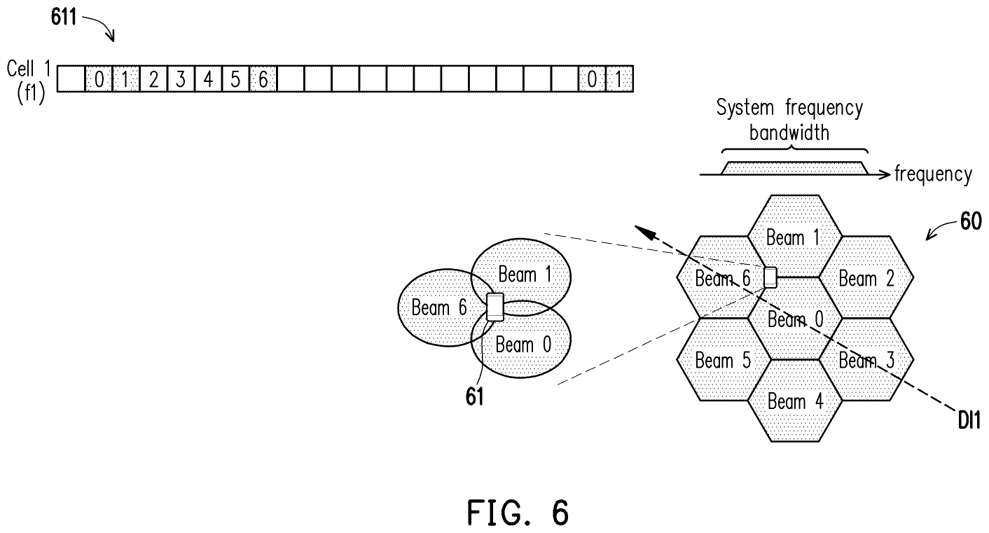

See FIG. 6, which shows a schematic diagram according to the first embodiment of the disclosure.

In FIG. 6, the considered NTN cell 60 (named as “Cell 1”) is assumed to broadcast the SSBs based on the broadcast pattern 611. In the broadcast pattern 611, the SSBs numbered as 0 to 6 (referred to as SSB 0 to SSB 6) would be sequentially transmitted on the frequency f1 in a TDM approach, and SSB 0 to SSB 6 may respectively correspond to Beam to Beam 6 provided by the NTN cell 60.

In addition, the UE 61 in FIG. 6 is assumed to be within the overlapping area where the coverages of Beam 0, Beam 1, and Beam 6 are overlapped (i.e., the location of UE 61 is covered by Beam 0, Beam 1, and Beam 6). In this case, the UE 61 may sequentially determine SSB 0, SSB 1, and SSB 6 as the detected SSBs based on the broadcast pattern 611, and the UE 61 may determine the first information based on the IDs of these detected SSBs.

For better understanding, the IDs of SSB 0, SSB 1, and SSB 6 may be respectively represented by 0, 1, and 6, but the disclosure is not limited thereto. In this case, the presentation order of the detected SSB may be determined to be {0, 1, 6}, but the disclosure is not limited thereto.

In FIG. 6, it is assumed that the satellite providing the NTN cell 60 may move along the direction DI1 with a particular velocity, and the network entity (e.g., the gNB) may provide this information along with the broadcast pattern of Beam 0 to Beam 6 to the UE 61, such that the UE 61 may accordingly derive the presentation order of SSB 0 to SSB 6.

In other embodiments, the network may directly provide the presentation order of

SSB 0 to SSB 6 after deriving the presentation order of SSB 0 to SSB 6 based on the direction DI1, the particular velocity of the satellite and the beam pattern of Beam 0 to Beam 6, but the disclosure is not limited thereto.

In the embodiment, the presentation order of SSB 0 to SSB 6 may be understood as the order of Beam 0 to Beam 6 for serving the coverage of an NTN cell.

Along the moving of a satellite, the presentation order of SSBs represents the viewpoint of a geographic area that the SSB IDs of an NTN cell could be detected in the geographic area in the sequential order of time. The presentation order of beams represents the viewpoint of a geographic area that the coverages of the beams of an NTN cell may cover/serve the geographic area in the sequential order of time. For example, the presentation order of SSB 0 to SSB 6 may be assumed to be {6, 5, 1, 0, 4, 2, 3}, which means that Beam 6, Beam 5, Beam 1, Beam 0, Beam 4, Beam 2, and Beam 3 would sequentially cover/serve the location of UE 61 along with the movement of the satellite.

In the embodiment, the presentation order of SSB 0 to SSB 6 may be regarded as a list of one or more reference SSB IDs of the NTN cell 60, wherein each reference SSB ID may be associated with a corresponding SSB transmitted by a beam of the NTN cell 60, and an order of each of the one or more reference SSB IDs in the list reflects the presentation order of the corresponding SSBs.

In this case, the elements in the presentation order (e.g., {6, 5, 1, 0, 4, 2, 3}) may be understood as the reference SSB IDs in the list, which respectively corresponding to SSB 6, SSB 5, SSB 1, SSB 0, SSB 4, SSB 2, and SSB 3. Based on the list, it can be observed that the presentation order of SSB 6, SSB 5, SSB 1, SSB 0, SSB 4, SSB 2, and SSB 3 are 1 to 7, respectively.

In the embodiment, the above list may be included in the first information. With the first information (e.g., the presentation order of the detected SSBs and the list), the UE may accordingly perform step S540 to determine the first SSB.

In one embodiment, the first SSB may be a particular SSB having a latest presentation order among the plurality of detected SSBs.

For example, the plurality of detected SSBs may be understood as SSB 0, SSB 1, and SSB 6 in FIG. 6. According to the list and/or the presentation order (e.g., {6, 5, 1, 0, 4, 2, 3}), SSB 0 has the latest presentation order among SSB 0, SSB1, and SSB 6. In this case, the UE 61 may select SSB 0 as the first SSB considered in step S540 and accordingly perform step S550.

In the embodiment, the particular SSB having the latest presentation order among the plurality of detected SSBs means that the beam corresponding to the particular SSB can serve/cover the UE 61 for the longest time. In other words, if the UE 61 selects the particular SSB as the first SSB, it means the UE 61 selects a beam with the maximum available serving time among all the beams cover/serve the location of UE 61, which may increase the possibility of performing a random access procedure successfully by the UE 61. In the embodiments of the disclosure, an SSB may be regarded as being detected by the UE if this SSB satisfies predetermined conditions.

In one embodiment, in response to determining that a received signal strength of an SSB exceeds a predefined threshold, the UE may determine that the SSB is a detected SSB. On the other hand, in response to determining that the received signal strength of the SSB does not exceed the predefined threshold, the UE may determine that the SSB is not a detected SSB.

From another perspective, in response to determining that the received signal strength of a certain SSB exceeds the predefined threshold, the UE may determine that the certain SSB has been detected (e.g., the certain SSB can be determined as belonging to the plurality of detected SSBs). On the other hand, in response to determining that the received signal strength of the certain SSB does not exceed the predefined threshold, the UE may determine that the certain SSB is not detected.

In addition, in response to determining that the received signal strength of an SSB exceeds the predefined threshold, the UE may determine that a positive indication of the SSB is detected (e.g., the SSB is available). On the other hand, in response to determining that the received signal strength of an SSB does not exceed the predefined threshold, the UE may determine that a negative indication of the SSB is detected (e.g., the SSB is unavailable).

In some embodiments, the position indication of the SSB may be used to determine whether the SSB can be regarded as being detected.

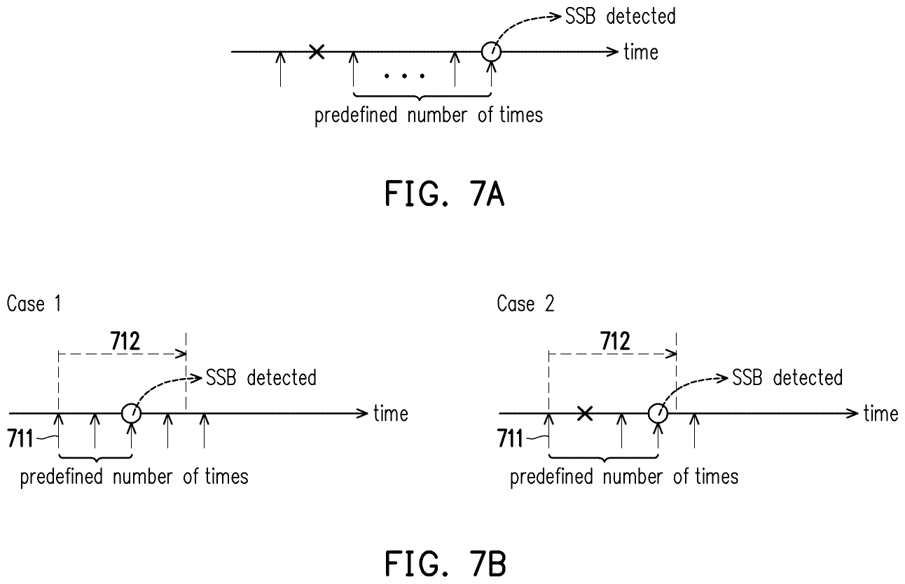

See FIG. 7A to FIG. 7C, which show several schematic diagrams of determining whether a SSB is detected according to embodiments of the disclosure.

In one embodiment, the UE may determine that a SSB is a detected SSB in response to determining that the positive indication of the SSB has been consecutively identified for a predefined number of times. From another perspective, the UE may determine that a certain SSB is detected in response to determining that the positive indication of the certain SSB has been consecutively identified for the predefined number of times.

In FIG. 7A, each arrow may be used to represent one positive indication of the certain SSB, and each cross (i.e., the symbol of “x) may be used to represent no positive indication of the certain SSB is detected as expected, but the disclosure is not limited thereto.

Therefore, when the UE determines that the positive indication of the certain SSB has been consecutively identified for the predefined number of times, the UE may determine that the certain SSB has been detected.

In another embodiment, in response to determining that the positive indication of an SSB has been identified for the predefined number of times within a predefined observation window, the UE may determine that the SSB is a detected SSB. From another perspective, in response to determining that the positive indication of a certain SSB has been identified for the predefined number of times within the predefined observation window, the UE may determine that the certain SSB has been detected.

In Case 1 of FIG. 7B, when the positive indication 711 is detected, the UE may accordingly determine the predefined observation window 712, wherein a start time of the predefined observation window 712 may corresponds to the time point of the positive indication 711, and a length of the predefined observation window 712 may be a predetermined time length, but the disclosure is not limited thereto.

For example, the predefined number of times may be assumed to be n. In this case, since 3 positive indications of a certain SSB has been identified within the predefined observation window 712, the UE may determine that the certain SSB has been detected.

Likewise, in Case 2 of FIG. 7B, since 3 positive indications of a certain SSB has been identified within the predefined observation window 712, the UE may determine that the certain SSB has been detected, but the disclosure is not limited thereto.

In one embodiment, the predefined observation window may be a sliding window, and the UE may perform the above determination based on the positive indications covered by the sliding window at different time.

For example, in Case 1 of FIG. 7C, the UE may determine that 3 positive indications of a certain SSB have been identified within the sliding window 721, and hence the UE may determine that the certain SSB has been detected.

In Case 2 of FIG. 7C, the UE may determine that only 2 positive indications of a certain SSB have been identified within the sliding window 722, and hence the UE may determine that the certain SSB is not detected. On the other hand, no positive indication of a certain SSB had been identified in the expected time, afterward a positive indication of a certain SSB has been identified in one of the following expected time within the sliding window, the UE may adjust the starting time of the sliding window as the sliding window (e.g., by adjusting the starting time of the sliding window 722 to the time of the previous positive indication had been identified) and the UE may determine that 3 positive indications of a certain SSB have been identified within the adjusted sliding window 723, and hence the UE may determine that the certain SSB has been detected, but the disclosure is not limited thereto.

In one embodiment, each entity of the list of SSB IDs may further be associated with an availability service duration of a corresponding random access resource.

In one embodiment, a NTN cell provides the average diameter of the beams of the NTN cell and the moving velocity of the satellite serving the NTN cell to UE (e.g., the average diameter of beams and the moving velocity of satellite are provided by System Information), and the service duration of a random access resource (e.g., a random access resource provided by a beam associated with a SSB ID) may be estimated by the UE based on information such as the average diameter of beams and/or the moving velocity of the satellite, but the disclosure is not limited thereto.

Taking FIG. 6 as an example, since the list is assumed to be {6, 5, 1, 0, 4, 2, 3}, the associated entities may be SSB 6, SSB 5, SSB 1, SSB 0, SSB 4, SSB 2, and SSB 3. In this case, the UE may estimate the service duration of the random access resources corresponding to SSB 6, SSB 5, SSB 1, SSB 0, SSB 4, SSB 2, and SSB 3. That is, the UE may estimate the service duration of Beam 6, Beam 5, Beam 1, Beam 0, Beam 4, Beam 2, and Beam 3, but the disclosure is not limited thereto.

In one embodiment, step S540 may be performed by the UE when initiating a random access procedure, or when the plurality of detected SSBs are determined.

For example, in the scenario of FIG. 6, the UE 61 may continuously append the SSB ID of the detected SSB into the list of SSB IDs and accordingly perform the selection of the first SSB when the UE initiates a random access procedure. Additionally or alternatively, the UE 61 perform the selection of the first SSB when the list include multiple SSB IDs, but the disclosure is not limited thereto.

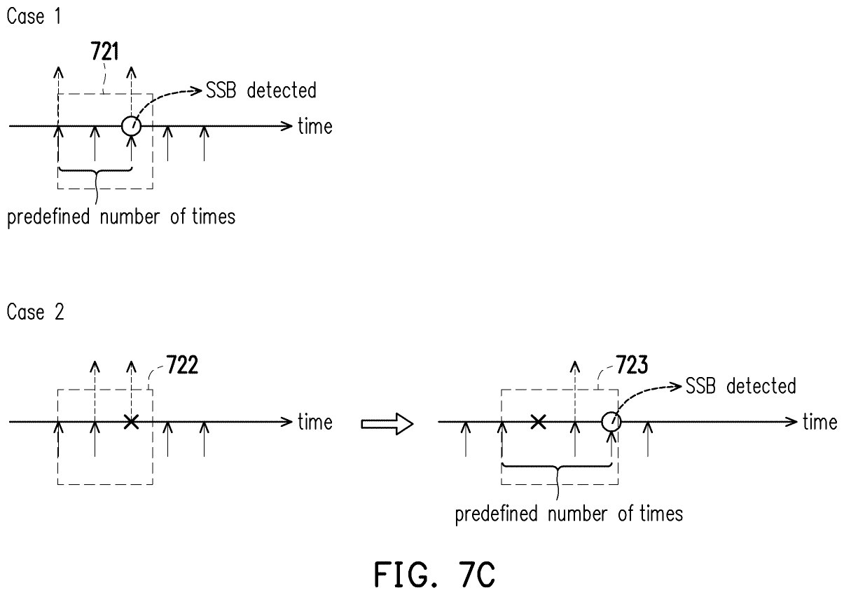

See FIG. 8, which shows a schematic diagram according to an embodiment of the disclosure. As mentioned in the above, the second information may be associated with an available service duration of a random access resource associated with the detected SSB ID.

In FIG. 8, it is assumed that a satellite provides Beam 1 and Beam 2 of an NTN cell. The moving velocity (e.g., the direction and speed) of the satellite is known to the UE 81. In addition, the diameters of Beam 1 and Beam 2 are also assumed to be known to the UE 81, and hence the average service duration of Beam 1 and Beam 2 may be derived by the UE 81 respectively.

In FIG. 8, the UE 81 firstly detects SSB 1 at time point TO (i.e., the time point when the UE 81 enters the coverage of Beam 1). The UE 81 adds SSB 1 and the time point TO to the list of SSB IDs. Afterward, the UE 81 firstly detects SSB 2 at time point T1. The UE 81 adds SSB 2 and the time point T1 to the list of SSB IDs. Thus, each entity of the list of SSB IDs includes the information of the SSB ID and the firstly detected time of the detected SSB.

In one embodiment, if the satellite moving velocity is v and the diameters of Beam and Beam 2 are D1 and D2, respectively, the UE 81 may determine the service duration of Beam 1 as D1/v, and the service duration of Beam 2 as D2/v.

In an example scenario, the UE 81 initiates random access procedure at time point T2, wherein the UE 81 is currently covered by Beam 1 and Beam 2. The UE 81 determines the available service duration 821 of the random access resource of Beam 1 may be (D1/v-(T2-TO)), and the available service duration 822 of the random access resource of Beam 2 may be (D2/v-(T2-T1)). If the available service duration 822 of the random access resource of Beam 2 is larger than the available service duration 821 of the random access resource of Beam 1, UE 81 determines SSB 2 as the first SSB and uses the random access resource associated with SSB 2 to perform a random access procedure.

In one embodiment, if the satellite moving velocity is v and the average diameter of beams of the NTN cell is D_average, the UE 81 may determine that the service duration of Beam 1 and Beam 2 is (D_average/v), but the disclosure is not limited thereto. In some embodiments, the value of (D_average/v) may be provided by the network to the UE 81 via system information, but the disclosure is not limited thereto.

In the scenario of FIG. 8, it is assumed that the UE 81 firstly detects Beam 1 at the time point TO (i.e., the time point when the UE 81 enters the coverage of Beam 1), and the UE 81 firstly detects Beam 2 at time point T1. The UE 81 initiates random access procedure at time point T2, wherein the UE 81 is currently covered by Beam 1 and Beam 2. The UE determines the available service duration 821 of the random access resource of Beam 1 may be (D_average/v-(T2-TO)), and the available service duration 822 of the random access resource of Beam 2 may be (D_average/v-(T2-T1)). If the available service duration of the random access resource of Beam 2 is larger than the available service duration of the random access resource of Beam 1, UE 81 determines SSB 2 as the first SSB and uses the random access resource associated with SSB 2 to perform a random access procedure.

In the embodiments, the first SSB may be the SSB corresponding to a longest available service duration among the detected SSBs.

In one embodiment, the second information may include one or more reference SSB IDs of the NTN cell, and each of the one or more reference SSB IDs is associated with a distance value for indicating the available service duration of a random access resource associated with the reference SSB ID.

In another embodiment, the second information may include one or more reference SSB IDs of the NTN cell, and each of the one or more reference SSB IDs is associated with a distance indicator, wherein each of the distance indicator indicates a distance between a first reference location associated with the corresponding reference SSB ID (e.g., the first reference location is located within the coverage of the beam associated with the SSB ID) and a second reference location associated with the NTN cell (i.e., the second reference location is a location within the coverage of the NTN cell and the location is not be limited to the coverage of a specific beam of the NTN cell).

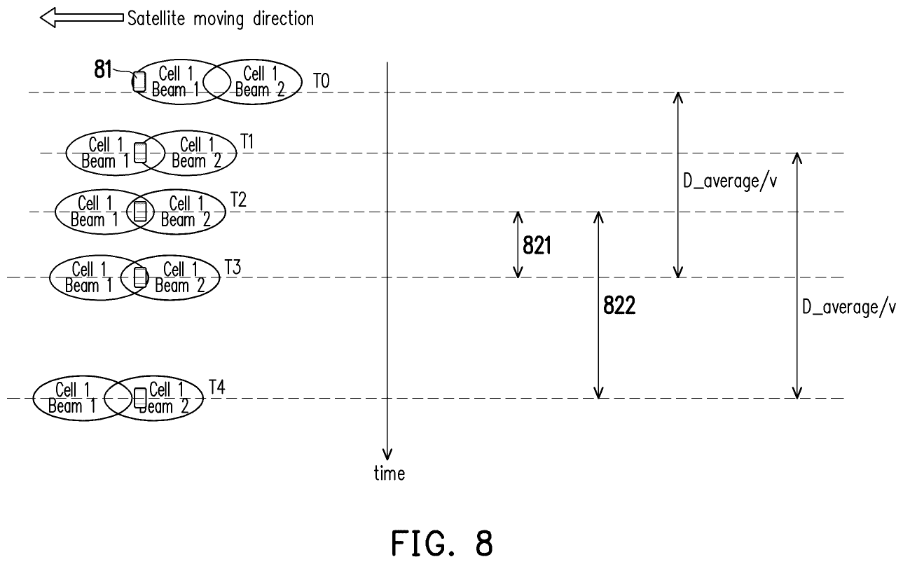

See FIG. 9, which shows a schematic diagram of providing distance indicators as the second information according to the second embodiment of the disclosure.

In FIG. 9, the considered NTN cell 90 (named as “Cell 1”) may provide Beam 0 to Beam 6, which may respectively correspond to SSB 0 to SSB 6.

In the embodiment, each beam may have a corresponding first reference location, Cell 1 may have a second reference location 910, and the distance indicator associated with the SSB ID may be determined accordingly. For better understanding, the position of the second reference location 910 may be assumed to be 0, but the disclosure is not limited thereto.

For example, Beam 0 may have a first reference location 920 (which may be a location within the coverage of Beam 0, such as the center) at a position of 3 distance units on the moving direction of the satellite. In this case, the distance indicator associated with SIB 0 (i.e., the SSB ID corresponding to Beam 0) may be determined as +3, wherein the plus sign means a positive value that the satellite will pass the first reference location 920 before passing the second reference location 910.

For example, Beam 1 may have a first reference location 921 (which may be a location within the coverage of Beam 1, such as the center) at a position of 1 distance unit on the moving direction of the satellite. In this case, the distance indicator associated with SSB 1 may be determined as +1, wherein the plus sign means that the satellite will pass the first reference location 921 before passing the second reference location 910.

For another example, Beam 2 may have a first reference location 922 (which may be a location within the coverage of Beam 2, such as the center) at a position of 2 distance unit on the opposite direction of the moving direction of the satellite. In this case, the distance indicator associated with SSB 2 may be determined as −2, wherein the minus sign means a negative value that the satellite will pass the first reference location 922 after passing the second reference location 910.

For Beam 3 to Beam 6, the associated distance indicators may be determined based on the above teachings, which would not be further provided.

In different embodiments, the distance indicators associated with the reference SSB IDs may be determined by the UE and/or the network to be used as an indication of an available service duration, but the disclosure is not limited thereto.

In the second embodiment, the UE may select the first SSB based on the distance indicators. In one embodiment, the first SSB may correspond to a minimum distance indicator among the detected SSBs. The distance indicator with a negative value is a value less than the distance indicator with positive value or value zero. The distance indicator with a value zero is less than the distance indicator with a positive value.

For example, in the scenario of FIG. 9, if the UE is covered by Beam 0 and Beam 1, the UE may determine SSB 0 and SSB 1 as the detected SSBs. In this case, since SSB corresponds to the minimum distance indicator (i.e., +1) among the detected SSBs (i.e., +3 associated with SSB 0 and +1 associated with SSB 1), the UE may determine SSB 1 as the first SSB and accordingly perform the random access procedure.

For another example, in the scenario of FIG. 9, if the UE is covered by Beam 1 and Beam 2, the UE may determine SSB 1 and SSB 2 as the detected SSBs. In this case, since SSB 2 corresponds to the minimum distance indicator (i.e.,−2) among the detected SSBs, the UE may determine SSB 2 as the first SSB and accordingly perform the random access procedure, but the disclosure is not limited thereto.

In one embodiment, the assistance information may further include a detection order list of a plurality of SSB IDs of (at least a part of) the plurality of SSBs, wherein the detection order list is organized by the UE based on a sequence in which each of the plurality of SSBs is determined as being detected. The order of an entity in the detection order list may be used as an indication of an available service duration.

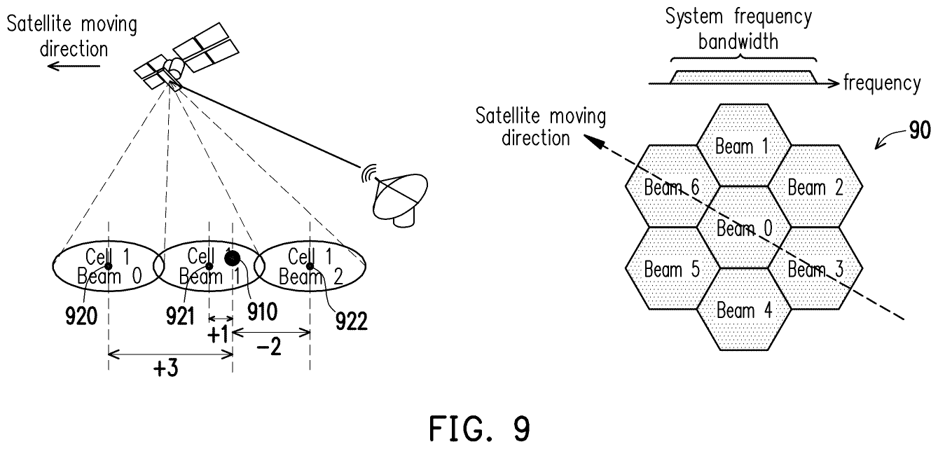

See FIG. 10, which shows a flow chart of the UE organizing the detection order list according to an embodiment of the disclosure.

In step S1010, the UE performs cell selection or cell reselection and camps on a cell.

In step S1020, the UE clears the detection order list after camping on the (re) selected cell.

In step S1030, the UE monitors SSB. For example, the UE may determine whether any SSB is detected based on the discussions of FIG. 7A to FIG. 7C, which would not be repeated herein.

In step S1040, the UE determines whether any new SSB associated to currently camped cell or the serving cell is detected. If not, the UE performs step S1030. If yes, the UE performs step S1050 to append the SSB ID of the newly detected SSB into the detection order list. Taking FIG. 6 as an example, since the UE 61 is assumed to sequentially detect SSB 0, SSB 1, and SSB 6, the UE 61 may be configured to perform: appending the SSB ID of SSB 0 into the detection order list when SSB 0 is determined to be detected; appending the SSB ID of SSB 1 into the detection order list when SSB 1 is determined to be detected; and appending the SSB ID of SSB 6 into the detection order list when SSB 6 is determined to be detected, but the disclosure is not limited thereto.

In one embodiment, when the UE performs step S540, the UE may determine the first SSB based on the detection order list. In the embodiment, the first SSB may be the last SSB ID in the detection order list.

For example, if the detection order list is {0, 1, 6}, the UE may determine SSB 6 as the first SSB and accordingly perform the random access procedure by using the random access resource associated with SSB 6. For another example, if the detection order list is {0, 3, 4}, the UE may determine SSB 4 as the first SSB and accordingly perform the random access procedure using the random access resource associated with SSB 4, but the disclosure is not limited thereto.

In the embodiments of the disclosure, the UE may determine whether to remove a certain SSB from the detection order list.

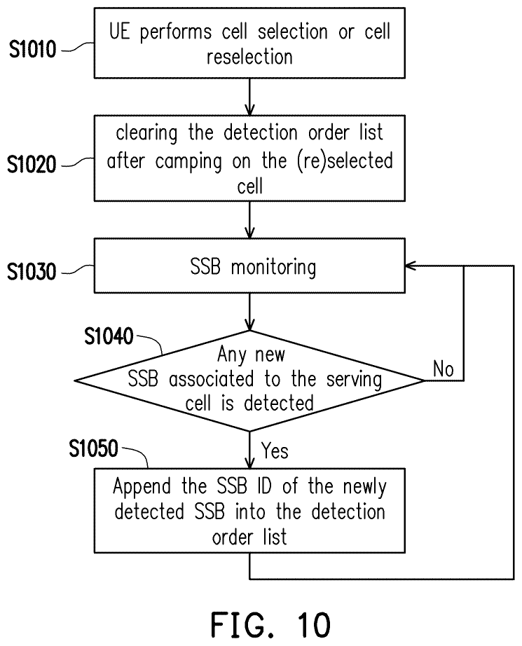

See FIG. 11, which shows schematic diagrams of removing an SSB from the detection order list according to an embodiment of the disclosure.

In the embodiment, a certain SSB is a detected SSB for the UE, the certain SSB is considered as valid to the UE. When the UE determines a positive indication of the certain SSB is detected, the UE may (re) start a timer associated with the certain SSB, and the timer may be configured to be a specific time length (which can be configured by the radio resource control (RRC) signalling) and starts to count down.

Next, the UE may determine whether another positive indication of the certain SSB is detected before the timer expires. If yes, the UE may determine the certain SSB is valid as shown in Case 1 of FIG. 11 and accordingly (re) start a timer. If no any positive indication of the certain SSB is detected before the time expires, the UE may determine the certain SSB is invalid as shown in Case 2 of FIG. 11 and accordingly remove the certain SSB from the detection order list.

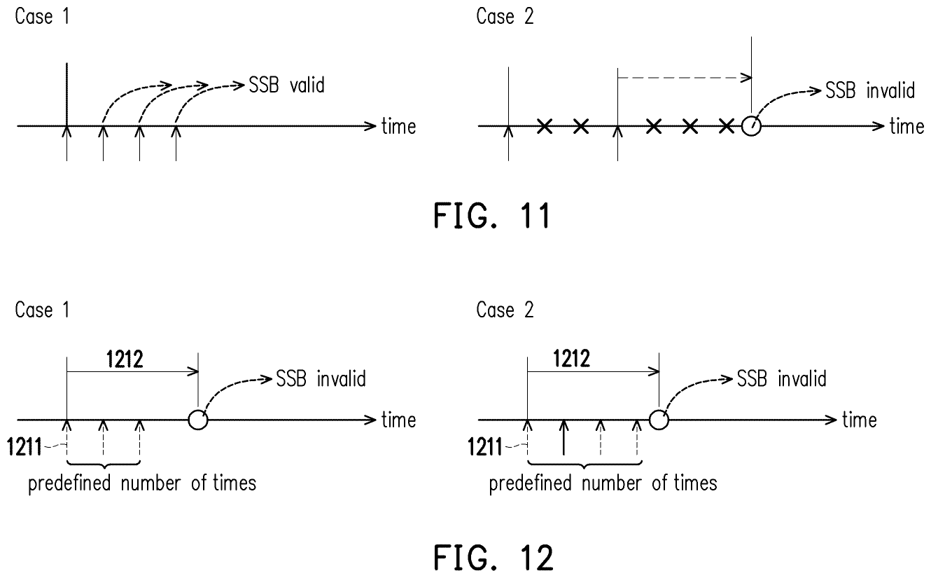

See FIG. 12, which shows schematic diagrams of removing an SSB from the detection order list according to an embodiment of the disclosure.

In one embodiment, in response to determining that the negative indication of a certain SSB has been identified for the predefined number of times within the predefined observation window, the UE may determine that the certain SSB has been invalid.

In FIG. 12, each solid arrow may be used to represent one positive indication of the certain SSB, and each dotted arrow may be used to represent one negative indication of the certain SSB (e.g., when no positive indication of the certain SSB is not be detected at an expected time, the UE considers it as a negative indication of the certain SSB is detected). Therefore, when the UE determines that the negative indication of the certain SSB has been identified for the predefined number of times in a predefined period of time, the UE may determine that the certain SSB has been invalid.

In Case 1 of FIG. 12, when the negative indication 1211 is detected, the UE may accordingly determine the predefined observation window 1212, wherein a start time of the predefined observation window 1212 may corresponds to the time point of the negative indication 1211, and a length of the predefined observation window 1212 may be a predetermined time length, but the disclosure is not limited thereto.

In the embodiment, the predefined number of times may be assumed to be 3. In this case, since 3 consecutive negative indications of a certain SSB has been identified within the predefined observation window 1212, the UE may determine that the certain SSB has been invalid and accordingly remove the certain SSB from the detection order list.

In Case 2 of FIG. 12, 3 negative indications of a certain SSB has been identified within the predefined observation window 1212, though the 3 negative indications of a certain SSB has not been consecutively identified by the UE, but the total number of negative indications are identified in the predefined observation window, the UE may determine that the certain SSB has been invalid and accordingly remove the certain SSB from the detection order list, but the disclosure is not limited thereto.

In FIG. 12, if the number of negative indications of a certain SSB has been identified in the predefined observation window 1212 does not exceed a predefined number of times, the UE may not remove the certain SSB form the detection order list.

In summary, the present disclosure provides a solution for the UE served by an NTN cell to better select the random access resource for performing the random access procedure. Accordingly, the frequency of the UE changing random access resource may be reduced, which prevents time waste caused by selecting an improper SSB.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for executing random access resource selection in a User Equipment (UE) served by a Non-Terrestrial Network (NTN), the method comprising:
detecting, by the UE, a synchronization signal block (SSB) transmitted by an NTN cell, based on a predefined communication resource associated with the SSB;
determining, by the UE, an identifier (ID) associated with the detected SSB;
maintaining, by the UE, assistance information, wherein the assistance information comprises at least one of the following:
first information associated with a presentation order of the detected SSB; and
second information associated with an available service duration of a random access resource associated with the detected SSB;
selecting, by the UE, one of the detected SSB as a first SSB based on the assistance information when a plurality of SSB are detected; and
applying, by the UE, a random access resource associated with the first SSB for performing a random access procedure.

2. The method according to claim 1, wherein the first information associated with the presentation order of the detected SSBs comprises:
a list of one or more reference SSB IDs of the NTN cell, each reference SSB ID being associated with a corresponding SSB transmitted by the NTN cell, wherein an order of each of the one or more reference SSB IDs in the list reflects the presentation order of the corresponding SSB.

3. The method according to claim 2, wherein the list further comprises one or more entities associated with the one or more reference SSB IDs, each entity being associated with an available service duration of a corresponding random access resource.

4. The method according to claim 1, wherein the second information comprises at least one of following information:
one or more reference SSB IDs of the NTN cell and each of the one or more reference SSB IDs is associated with an available service duration;
one or more reference SSB IDs of the NTN cell and each of the one or more reference SSB IDs is associated with a distance value;
one or more reference SSB IDs of the NTN cell and each of the one or more reference SSB IDs is associated with a distance indicator, wherein each of the distance indicator indicates a distance between a first reference location associated with the corresponding reference SSB ID and a second reference location associated with the NTN cell.

5. The method according to claim 1, further comprising:
in response to determining that a received signal strength of a SSB exceeds a predefined threshold, determining that the SSB is a detected SSB;
in response to determining that a positive indication of a SSB has been consecutively identified for a predefined number of times, determining that the SSB is a detected SSB; or
in response to determining that the positive indication of a SSB has been identified for the predefined number of times within a predefined observation window, determining that the SSB is a detected SSB.

6. The method according to claim 1, wherein selecting, by the UE, the one of the plurality of detected SSBs as the selected SSB based on the assistance information comprises:
selecting, by the UE, the one of the plurality of detected SSBs as the first SSB based on the assistance information when initiating a random access procedure, or when the plurality of detected SSBs are determined.

7. The method according to claim 1, wherein the assistance information further comprises:
a detection order list of a plurality of SSB IDs of the plurality of SSBs, wherein the detection order list is organized by the UE based on a sequence in which each of the plurality of SSBs is determined as being detected.

8. The method according to claim 1, wherein the selected SSB corresponds to the random access resource associated with the SSB having a longest available service duration among the plurality of detected SSBs; or
the selected SSB is a most recently detected SSB among the plurality of detected SSBs.

9. User equipment (UE) configured for operation in a Non-Terrestrial Network (NTN), the UE comprising:
a transceiver; and
a processor, coupled to the transceiver, configured to perform:
controlling the transceiver to detect a synchronization signal block (SSB) transmitted by an NTN cell, based on a predefined communication resource associated with the SSB;
determining an identifier (ID) associated with the detected SSB;
maintaining assistance information, wherein the assistance information comprises at least one of the following:
first information associated with a presentation order of the detected SSB; and
second information associated with an available service duration of a random access resource associated with the detected SSB;
selecting one of the detected SSB as a first SSB based on the assistance information when a plurality of SSB are detected; and
applying a random access resource associated with the first SSB for performing a random access procedure.

10. The UE according to claim 9, wherein the first information associated with the presentation order of the detected SSBs comprises:
a list of one or more reference SSB IDs of the NTN cell, each reference SSB ID being associated with a corresponding SSB transmitted by the NTN cell, wherein an order of each of the one or more reference SSB IDs in the list reflects the presentation order of the corresponding SSB.

11. The UE according to claim 10, wherein the list further comprises one or more entities associated with the one or more reference SSB IDs, each entity being associated with an available service duration of a corresponding random access resource.

12. The UE according to claim 9, wherein the second information comprises at least one of following information:
one or more reference SSB IDs of the NTN cell and each of the one or more reference SSB IDs is associated with an available service duration;
one or more reference SSB IDs of the NTN cell and each of the one or more reference SSB IDs is associated with a distance value for indicating the available service duration of a reference random access resource associated with the reference SSB ID;
one or more reference SSB IDs of the NTN cell and each of the one or more reference SSB IDs is associated with a distance indicator, wherein each of the distance indicator indicates a distance between a first reference location associated with the corresponding reference SSB ID and a second reference location associated with the NTN cell.

13. The UE according to claim 9, wherein the processor is further configured to perform:
in response to determining that a received signal strength of a SSB exceeds a predefined threshold, determining that the SSB is a detected SSBs;
in response to determining that a positive indication of a SSB has been consecutively identified for a predefined number of times, determining that the SSB is a detected SSB; or
in response to determining that the positive indication of a SSB has been identified for the predefined number of times within a predefined observation window, determining that the SSB is a detected SSB.

14. The UE according to claim 9, wherein the processor is configured to perform:
selecting, by the UE, the one of the plurality of detected SSBs as the first SSB based on the assistance information when initiating a random access procedure, or when the plurality of detected SSBs are determined.

15. The UE according to claim 9, wherein the assistance information further comprises:
a detection order list of a plurality of SSB IDs of the plurality of SSBs, wherein the detection order list is organized by the UE based on a sequence in which each of the plurality of SSBs is determined as being detected.

16. The UE according to claim 9, wherein the selected SSB corresponds to the random access resource associated with the SSB having a longest available service duration among the plurality of detected SSBs; or
the selected SSB is a most recently detected SSB among the plurality of detected SSBs.
